(19) United States
(12) Patent Application Publication
(10) Pub. No.: US 2014/0313528 A1
(43) Pub. Date: Oct. 23, 2014

(54) PRINT SETTING APPARATUS AND NON-TRANSITORY COMPUTER-READABLE RECORDING MEDIUM STORED WITH CONTROL PROGRAM OF PRINT SETTING APPARATUS

(71) Applicant: KONICA MINOLTA, INC., Chiyoda-ku (JP)

(72) Inventor: Naoyo SUZUKI, Tama-shi (JP)

(73) Assignee: KONICA MINOLTA, INC., Chiyoda-ku (JP)

(21) Appl. No.: 14/252,898

(22) Filed: Apr. 15, 2014

(30) Foreign Application Priority Data
Apr. 18, 2013 (JP) 2013-087762

(51) Int. Cl. G06K 15/02

(52) U.S. Cl. CPC G06K 15/027; G06K 15/1878
USPC 358/1.9

(57) ABSTRACT

A PC performing print setting of print data to be output by a printer capable of executing a plurality of calibration methods, including a selection unit that selects one color profile as a color profile to be used for color conversion of the print data from a plurality of color profiles, a determination unit that determines whether a first calibration method executed at a time of creation of one color profile selected by the selection unit agrees with a second calibration method currently registered in the printer, with reference to the one color profile selected by the selection unit and a correction table indicating a correspondence relation between output characteristic values of the printer before and after correction by the second calibration method, and a first notification unit that notifies a user of a determination result by the determination unit.

### CROSS-REFERENCE TO RELATED APPLICATION

This application is based on Japanese Patent Application No. 2013-087762 filed on Apr. 18, 2013, the contents of which are incorporated herein by reference.

### BACKGROUND

1. Technical Field

The present invention relates to a print setting apparatus performing print setting of print data output by an image forming apparatus which can execute a plurality of calibration methods and a non-transitory computer readable recording medium stored with a control program of the print setting apparatus.

2. Description of Related Art

In markets of color management, several data sets formed by device values and color measurement values are distributed as industry standard colors. Examples of the industry standard colors include JapanColor2011, Fogra39, and GRACol (General Requirements for Applications in Commercial Offset Lithography) that conform to international standards of ISO (International Organization for Standardization). Also, profiles created based on such industry standard colors are also available in the markets.

In recent years, since color reproduction of grey has become important in the markets, grey calibration methods suitable for respective industry standard colors have been suggested. For example, G7 Calibration has been suggested as the grey calibration method suitable for GRACol by IDEAlliance (International Digital Enterprise Alliance). There are also several known grey calibrations developed uniquely by printer makers.

Correction methods by such grey calibrations are decided based on respective unique ideas. Therefore, when different grey calibrations are used, different correction results may be obtained. Accordingly, print systems configured to enable selecting one method from a plurality of grey calibration methods suitable for respective industry standard colors have been spread to meet requirements of users in various industries. As a result, a plurality of calibration methods are mixed in a single print system. Thus, for example, when a calibration method executed at the time of creation of a color profile for color conversion is not registered in a current printer, a problem occurs in that color reproduction accuracy desired by a user may not be obtained.

Accordingly, Japanese Unexamined Patent Application Publication No. 2012-178800 suggests a printer that performs setting adjustment of mechanical conditions of an apparatus, e g., a sheet feeding amount, temperature and wind power at the time of drying, and a head speed, according to a print result of a test pattern. Japanese Unexamined Patent Application Publication No. 2007-6208 suggests an output density adjustment system that displays warning information when calibration data defining a relation between an output density and a standard density of a printer satisfies a predetermined condition. Japanese Unexamined Patent Application Publication No. 2011-223620 suggests a print instruction terminal that acquires a plurality of profiles in which sheet type information at the time of output of a color chart is embedded, compares the sheet type information extracted from these profiles to sheet type information at the time of printing, and performs display so that one or the plurality of profiles extracted from the comparison result can be selected.

However, although the technologies suggested in the patent documents are used, the problem that color reproduction accuracy of an output image deteriorates still remains unresolved when a calibration method executed at the time of creation of a color profile is not registered in a current printer.

### SUMMARY

The invention is devised in view of the problems of the foregoing technologies of the related art and an object of the invention is to provide a print setting apparatus preventing color reproduction accuracy of an output image from deteriorating when a calibration method executed at the time of creation of a color profile for color conversion is not registered in an image forming apparatus and a non-transitory computer readable recording medium stored with a control program of the print setting apparatus.

To achieve at least one of the abovementioned objects, a print setting apparatus reflecting one aspect of the present invention, is applied to perform print setting of print data to be output by an image forming apparatus capable of executing a plurality of calibration methods, and includes a selection unit, a determination unit and a first notification unit. The selection unit selects one color profile as a color profile to be used for color conversion of the print data from a plurality of color profiles. The determination unit determines whether a first calibration method executed at a time of creation of one color profile selected by the selection unit agrees with a second calibration method currently registered in the image forming apparatus, with reference to the one color profile selected by the selection unit and a calibration table indicating a correspondence relation between output characteristic values of the image forming apparatus before and after correction by the second calibration method. The first notification unit notifies a user of a determination result by the determination unit.

It is preferable in the above print setting apparatus that the determination unit determines whether the first calibration method agrees with the second calibration method, by identifying the first calibration method based on identification information described in advance in the one color profile selected by the selection unit and identifying the second calibration method based on the calibration table.

It is preferable in the above print setting apparatus that the determination unit determines whether the first calibration method agrees with the second calibration method, by identifying the first calibration method based on a correspondence relation between a device value and a device-independent value shown in the one color profile selected by the selection unit and identifying the second calibration method based on the calibration table.

It is preferable that a retrieval unit that retrieves, among the plurality of color profiles, a color profile which is other color profile different from the one color profile selected by the selection unit and for which the first calibration method is executed at the time of creation of the other color profile, when it is determined that the first calibration method does not agree with the second calibration method, and a second notification unit that notifies the user of a retrieval result of the other color profile by the retrieval unit are further included in the above print setting apparatus.

It is preferable that an optimization unit that optimizes the calibration table in accordance with the first calibration method, when it is determined that the first calibration method does not agree with the second calibration method is further included in the above print setting apparatus.

To achieve at least one of the abovementioned objects, a non-transitory computer readable recording medium reflecting another aspect of the present invention, is stored with a control program of a print setting apparatus performing print setting of print data to be output by an image forming apparatus capable of executing a plurality of calibration methods, the control program causing the print setting apparatus to execute the procedures (A), (B) and (C). In the procedure (A), one color profile is selected as a color profile to be used for color conversion of the print data from a plurality of color profiles. In the procedure (B), it is determined whether a first calibration method executed at a time of creation of the one color profile selected in the procedure (A) agrees with a second calibration method currently registered in the image forming apparatus, with reference to the one color profile selected in the procedure (A) and a calibration table indicating a correspondence relation between output characteristic values of the image forming apparatus before and after correction by the second calibration method. In the procedure (C), a user is notified of a determination result in the procedure (B).

The objects, features, and characteristics of this invention other than those set forth above will become apparent from the description given herein below with reference to preferred embodiments illustrated in the accompanying drawings.

### BRIEF DESCRIPTION OF THE DRAWING

FIG. 1 is a block diagram illustrating the configuration of a print system according to an embodiment of the invention.

FIG. 2 is a block diagram illustrating the configuration of a print setting apparatus (PC 1) according to the embodiment of the invention.

FIG. 3 is a schematic diagram illustrating an example of a calibration setting screen according to the embodiment of the invention.

FIG. 4 is a schematic diagram illustrating an example of a print setting screen according to the embodiment of the invention.

FIG. 5 is a flowchart illustrating a procedure of profile creation process according to the embodiment of the invention.

FIG. 6 is a flowchart illustrating a procedure of print setting process according to the embodiment of the invention.

FIG. 7 is a flowchart illustrating a procedure of calibration method determination process according to the embodiment of the invention.

FIG. 8 is a schematic diagram illustrating an example of a determination result notification screen according to the embodiment of the invention.

FIG. 9 is a schematic diagram illustrating an example of the determination result notification screen according to the embodiment of the invention.

FIG. 10 is a flowchart illustrating a procedure of printer profile retrieval process according to the embodiment of the invention.

FIG. 11 is a schematic diagram illustrating an example of a retrieval result display screen according to the embodiment of the invention.

FIG. 12 is a schematic diagram illustrating an example of an optimization table display screen according to the embodiment of the invention.

FIG. 13 is a flowchart illustrating a procedure of calibration table optimization process according to the embodiment of the invention.

### DETAILED DESCRIPTION

Hereinafter, an embodiment of the invention will be described in detail with reference to the drawings.

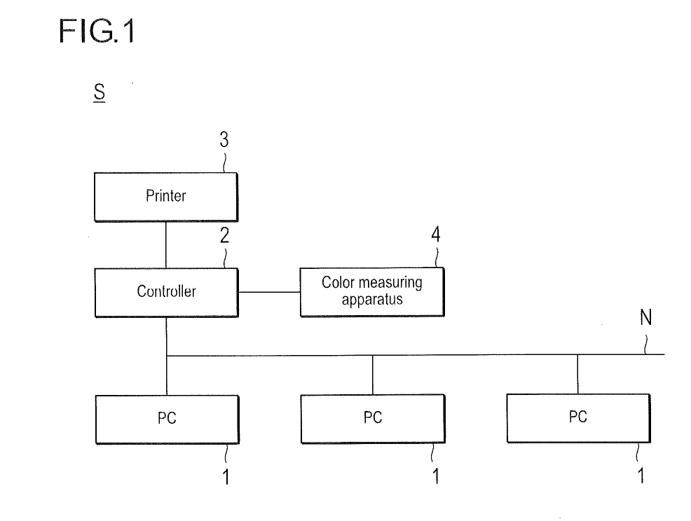

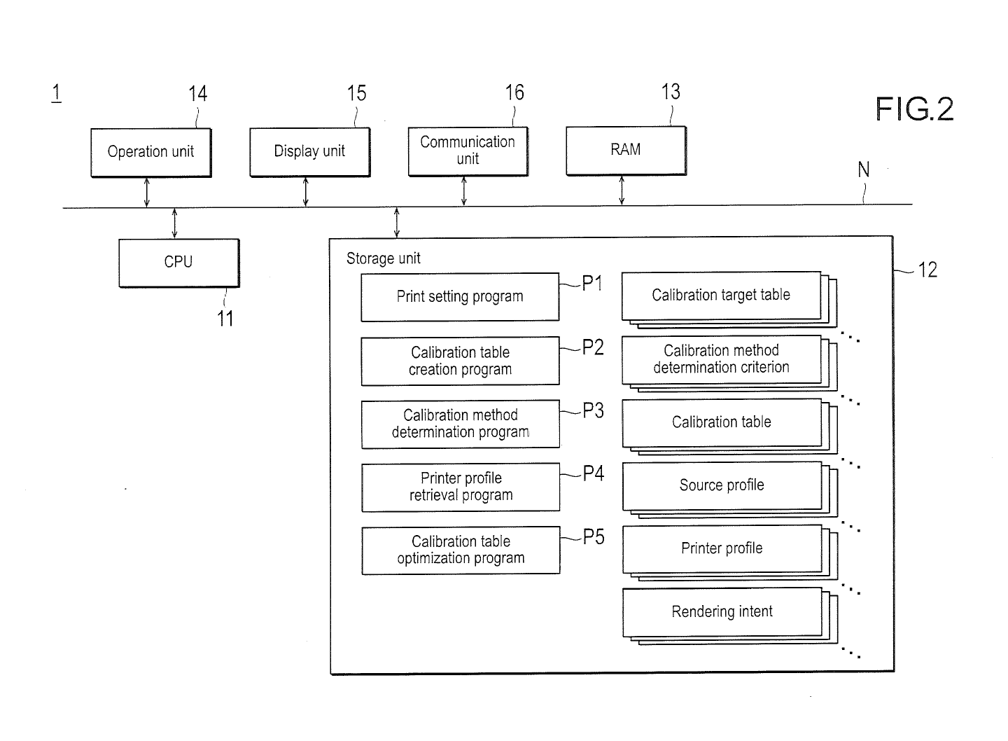

FIG. 1 is a block diagram illustrating the configuration of a print system S according to the embodiment of the invention. FIG. 2 is a block diagram illustrating the configuration of a PC 1 in FIG. 1. As shown in FIG. 1, the print system S includes a print setting apparatus (PC 1), an image processing apparatus (controller 2), and an image forming apparatus (printer 3).

In FIG. 1, the PC 1 has a function of generating print data to be output by the printer 3. The controller 2 has a function of executing a color conversion process, a rasterizing process, a screening process, and the like on the print data received from the PC 1 to generate raster data for a print process. The printer 3 has a function of executing an electrophotographic print process based on the raster data received from the controller 2. A print type adapted in the printer 3 may be an impact type, a thermal transfer type, an ink jet type, or the like.

As shown in FIG. 1, the PC 1 and the controller 2 are connected to each other via a network N, and the controller 2 and the printer 3 are locally connected to each other. Here, the network N is, for example, a LAN (Local Area Network) that conforms to a standard such as Ethernet (registered trademark), Token Ring, or FDDI (Fiber-Distributed Data Interface) or a WAN (Wide Area Network) in which LANs are connected by a dedicated line. The controller 2 in FIG. 1 is an apparatus independent from the printer 3, but is included in the printer 3 in some cases.

As shown in FIG. 1, a color measuring apparatus 4 that includes a color measuring device such as a colorimeter or a spectrophotometer is locally connected to the controller 2. The color measuring apparatus 4 has a function of measuring various color charts output from the printer 3. Color measurement values measured by the color measuring apparatus 4 are device-independent values such as L*a*b* values or XYZ values. The color measuring apparatus 4 is connected to the PC 1 or the printer 3 in some cases and is connected to the network N in some cases rather than the controller 2.

The print system S according to the embodiment has a function of executing calibration of the printer 3 according to a plurality of calibration methods. The “calibration” mentioned here refers to a procedure of correcting a change in output characteristics of the printer 3 to maintain color reproducibility of the printer 3 in a certain condition. More specifically, the print system S creates a correction table indicating a correspondence relation between output characteristic values (such as density values or brightness values) of the printer 3 before and after the calibration by means of a color measurement value of a color chart output by the printer 3 and a target table to be described below. Such a correction table is referred to as a “calibration table” below.

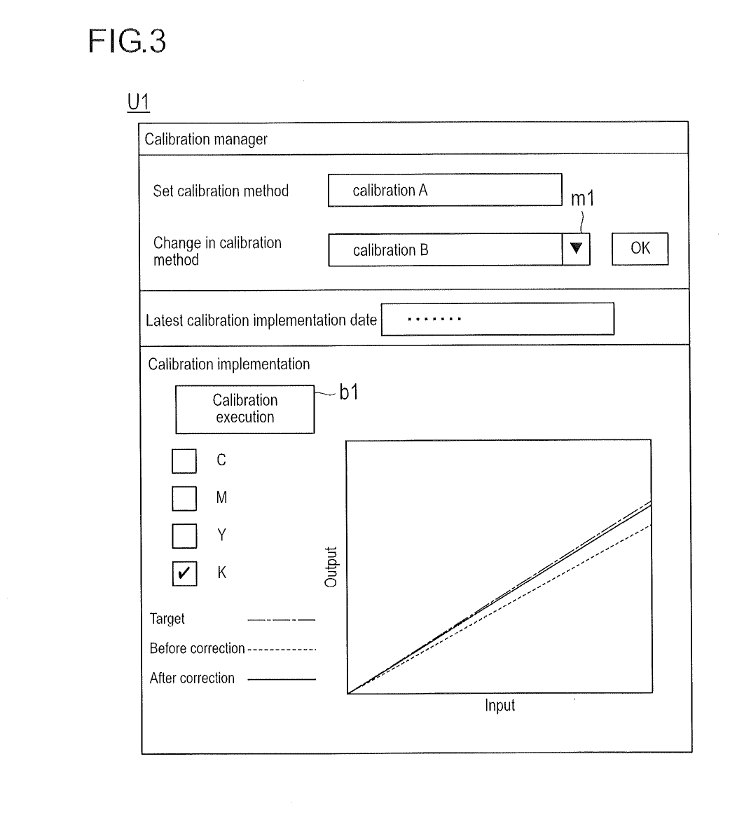

Software for performing detailed setting of the calibration of the printer 3 is installed in the controller 2 according to the present embodiment. Such software is generally referred to as a “calibration manager.” FIG. 3 is a schematic diagram illustrating an example of an operation screen provided by the calibration manager according to the present embodiment, i.e., an example of a calibration setting screen U1.

On the calibration setting screen U1 in FIG. 3, one calibration method can be selected from a plurality of calibration methods by operating a pull-down menu m1 of a “change in calibration method” field. Then, the calibration can be executed using the currently selected calibration method by pressing a “calibration execution” button b1 of a “calibration implementation” field.

Next, a detailed configuration of the PC 1 according to the present embodiment will be described. Since the controller 2 according to the present embodiment is an ordinary printer controller and the printer 3 according to the present embodiment is an ordinary printer, the detailed description thereof will be omitted. As shown in FIG. 2, the PC 1 includes a CPU (Central Computing Unit) 11, a storage unit 12, a RAM (Random Access Memory) 13, an operation unit 14, a display unit 15, and a communication unit 16 which are connected to each other via a bus 17 to exchange signals.

The CPU 11 controls an operation of each unit according to a program stored in the storage unit 12 and executes various data processing. As shown in FIG. 2, the storage unit 12 stores programs such as a print setting program P1, a calibration table creation program P2, a calibration method determination program P3, a printer profile retrieval program P4, and a calibration table optimization program P5.

Here, the print setting program P1 has a function of performing print setting of document files created by various applications. More specifically, the print setting program P1 has a function of generating print data of a document file and transmitting the print data to the printer controller 2. The print data according to the present embodiment is described in PDL (Page Description Language) such as Postscript (registered trademark).

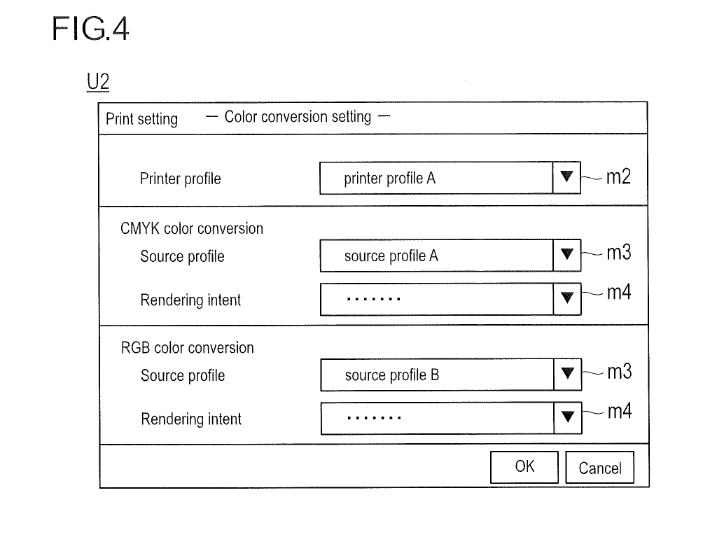

FIG. 4 is a schematic diagram illustrating an example of a print setting screen U2 provided by the print setting program P1 according to the present embodiment. On the print setting screen U2 in FIG. 4, a printer profile, source profiles, and rendering intents used in the color conversion process of the print data can be selected by operating menu lists m2, m3, and m4.

Here, the printer profile is a conversion table (LUT: Look Up Table) indicating a correspondence relation between device values (CMYK values) and device-independent values (such as L*a*b* values, XYZ values, etc.) of an output apparatus (printer 3) in the color conversion process. The source profile is a conversion table (LUT) indicating a correspondence relation between a standard color space (such as JapanColor2011, GRACol, etc.) which is a target in the color conversion process, or device values (such as RGB values, CMYK values, etc.) of an input apparatus (such as a display, a scanner, etc.) and device-independent values (such as L*a*b* values, XYZ values, etc.). In the following description, L*a*b* values are used as the device-independent values.

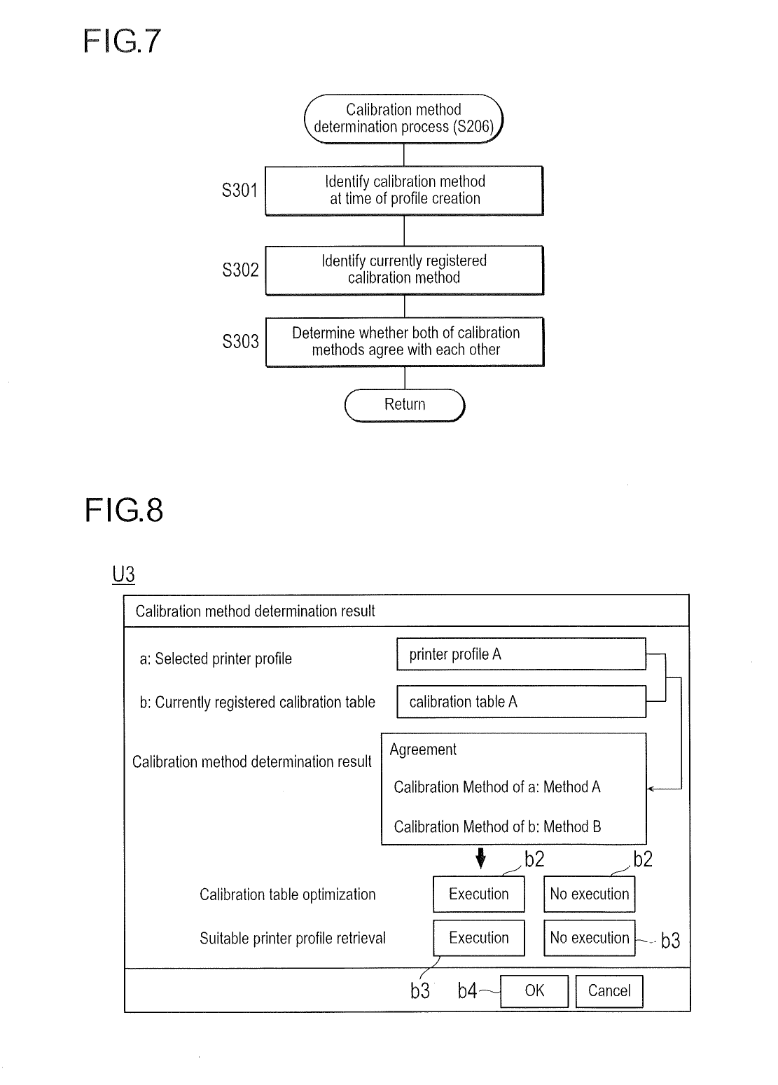

Referring back to FIG. 2, the calibration table creation program P2 has a function of creating the above-described calibration table. The calibration method determination program P3 has a function of determining whether a calibration method executed at the time of creation of a printer profile selected on the print setting screen agrees with a calibration method registered in the current printer 3. The details of this function will be described below with reference to the flowchart of FIG. 7.

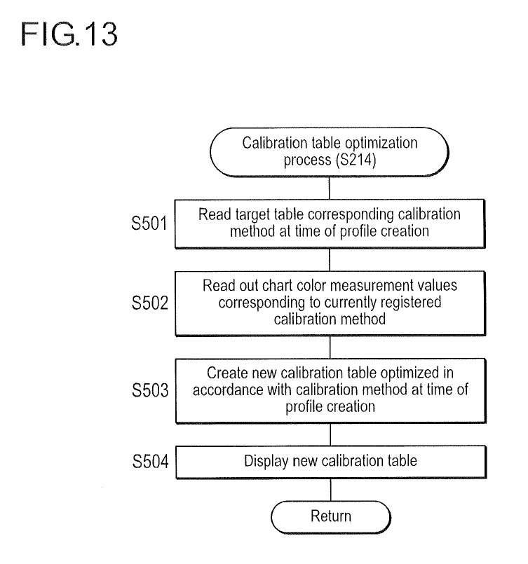

The printer profile retrieval program P4 has a function of retrieving another color profile suitable for the calibration method registered in the current printer 3 when the determination result by the calibration method determination program P3 is “DISAGREEMENT.” The details of this function will also be described below with reference to FIG. 10. The calibration table optimization program P5 has a function of optimizing the calibration table in accordance with the calibration method executed at the time of the creation of the printer profile when the determination result by the calibration method determination program P3 is “DISAGREEMENT.” The details of this function will also be described below with reference to the flowchart of FIG. 13.

The storage unit 12 is a non-volatile storage area formed by a ROM (Read Only Memory), an HDD (Hard Disk Drive), or the like and has a function of storing various kinds of data including a control program of the PC 1. As shown in FIG. 2, the storage unit 12 stores data of a calibration target table, a calibration method determination criterion, the calibration table, the source profile, the printer profile, the rendering intent, and the like in addition to the above programs P1 to P5.

Here, the “calibration target table” refers to a conversion table indicating a target value of the device-independent value corresponding to a device value after the execution of the calibration. The calibration target table is mainly used to create the calibration table (see FIG. 1). The “calibration method determination criterion” refers to collation data formed by combination of one or more device values and the device-independent values corresponding to the device values. The calibration method determination criterion is mainly used to identify a calibration method executed at the time of the creation of the printer profile (see FIG. 7).

The “calibration table,” the “printer profile,” and the “source profile” have been described above. Also, the “rendering intent” refers to setting information regarding rendering intent selectable on the print setting screen illustrated in FIG. 4. As shown in FIG. 2, the storage unit 12 stores the “calibration target table,” the “calibration method determination criterion,” and the “calibration table” respectively corresponding to the plurality of calibration methods executable in the print system S.

The RAM 13 has a function of temporarily storing various kinds of data as a working area of the CPU 11. The operation unit 14 is a keyboard, a mouse, a touch panel, or the like and has a function of receiving various operation instructions from a user. The display unit 15 is a display device such as an LCD (Liquid Crystal Display) or an organic EL (electroluminescence) display and has a function of displaying various kinds of information to the user. In particular, setting screens exemplified in FIGS. 4, 8, 9, 11, 12, etc. are displayed on the display unit 15. The communication unit 16 is a communication device such as an NIC (Network Interface Card) and has a function of connecting the PC 1 to the network N. The communication unit 16 conforms to the communication standard such as Ethernet (registered trademark), Token Ring, or FDDI.

Next, an overview of an operation of the print system S according to the present embodiment will be described. FIG. 5 is a flowchart illustrating a procedure of creating the printer profile of the printer 3 in the print system S. This process is referred to as a “profile creation process” below.

First, the print system S executes calibration of the printer 3 by causing the respective apparatuses to cooperate with each other (step S101). More specifically, in step S101, a chart for calibration is printed by the printer 3 and a patch in the chart is measured by the color measuring apparatus 4. Then, the calibration table creation program P2 of the PC 1 is activated to create a calibration table. At this time, the calibration table creation program P2 creates the calibration table by means of the color measurement value acquired from the color measuring apparatus 4 and the calibration target table in the storage unit 12.

Subsequently, the print system S prints a color chart for profile creation without execution of the color conversion process by the controller 2 (step S102). In this example, a color chart conforming to the standard of ISO 12642 is adopted as the color chart for the profile creation. Then, the print system S measures the color patch in the color chart with the color measuring apparatus 4 (step S103).

Subsequently, the print system S creates a first LUT of the printer 3 by means of the color measurement value acquired in step S103 (step S104). More specifically, in step S104, an LUT (CMYK values=>L*a*b* values) in which color measurement values (L*a*b* values) respectively corresponding to 4-dimensional lattice points formed from C, M, Y, and K are described is created.

Subsequently, the print system S creates a second LUT of the printer 3 by means of the color measurement values acquired in step S103 (step S105). More specifically, in step S105, an LUT (L*a*b* values=>CMYK values) in which device values (CMYK values) respectively corresponding to 3-dimensional lattice points formed from L*, a*, and b* are described is created. The LUT created in this way is a printer profile of the printer 3. Thereafter, the print system S ends the profile creation process.

In step S105, various kinds of private information can be described in the printer profile. In particular, identification information of the calibration method executed in step S101 is preferably described as a part of the private information. The identification information described in the printer profile may be the calibration method itself or may be an attribute code corresponding to the calibration method. The step S104 and step S105 are executed by a profiler commercially available from each maker or a dedicated profiler designed to describe the above-mentioned identification information in the printer profile.

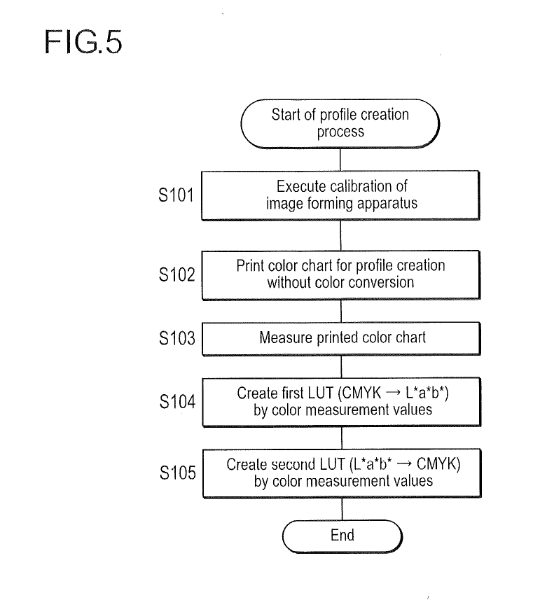

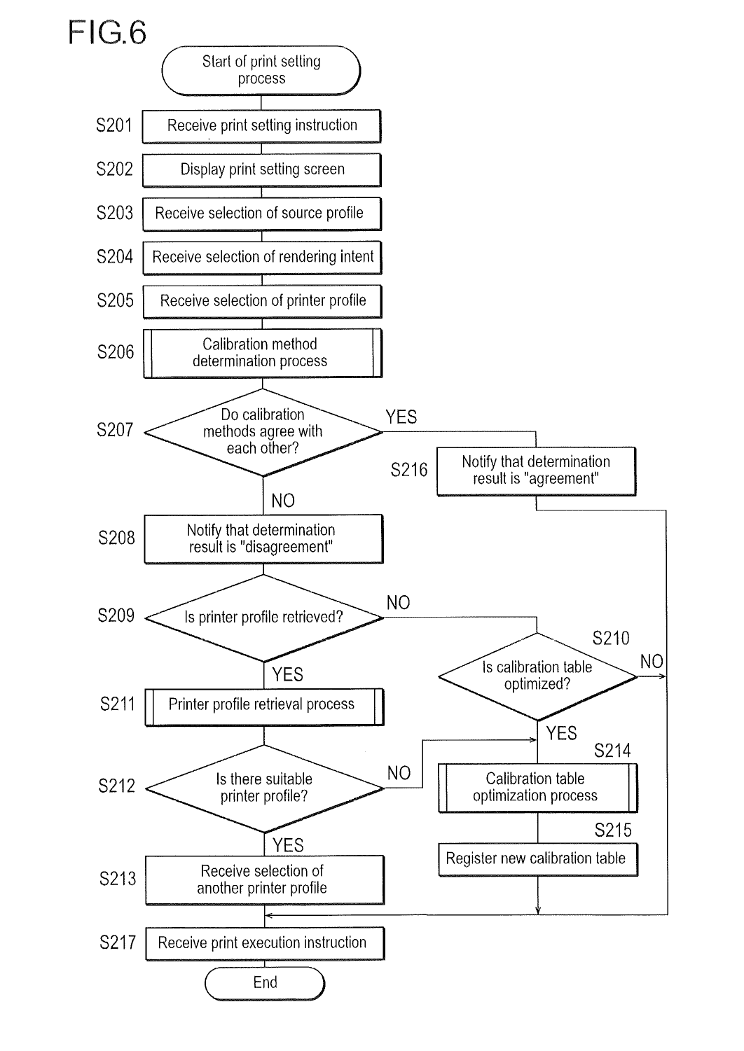

Consecutively, an overview of an operation of the print system S according to the present embodiment will be described. FIG. 6 is a flowchart illustrating a process in which the PC 1 performs print setting on the print data according to the present embodiment. This is referred to as a “print setting process” below. As shown in FIG. 6, when the PC 1 receives a print setting instruction from the user through any of various applications (step S201), the PC 1 first displays the print setting screen U2 illustrated in FIG. 4 on the display unit 15 (step S202).

Subsequently, the PC 1 receives selection of the source profile, the rendering intent, and the printer profile on the print setting screen U2 (step S203, step S204, and step S205). Thereafter, the PC 1 determines whether the calibration method currently registered in the printer 3 agrees with the calibration method executed at the time of the creation of the printer profile selected in step S205 (step S206). The process of step S206 is referred to as a “calibration method determination process” below.

The calibration method currently registered in the printer 3 refers to a calibration method executed at the time of the calibration executed finally at the present time. Also, the calibration method executed at the time of the creation of the printer profile refers to a calibration method registered in the printer 3 at the time of the printing of the color chart for the profile creation, i.e., the calibration method executed in step S101 of FIG. 5.

The former calibration method is referred to as a “currently registered calibration method” below. The currently registered calibration method can be confirmed in a “set calibration method” field of the calibration setting screen in FIG. 3. Also, the latter calibration method is referred to as a “calibration method at the time of the profile creation” below.

Here, the printer profile selected in step S205 is created based on the color measurement values in a condition in which the latter calibration method has been executed. Therefore, when both of the calibration methods do not agree with each other, there is a probability that color reproducibility of the output image by the printer 3 deteriorates. For this reason, the PC 1 according to the present embodiment determines whether both of the calibration methods agree with each other and notifies the user of the determination result before the printing process of the printer 3. This point will be further described below.

FIG. 7 is a flowchart illustrating a procedure of calibration method determination process (step S206). As shown in FIG. 7, the PC 1 first identifies the calibration method at the time of the profile creation corresponding to the printer profile selected in step S205 (step S301). More specifically, in step S301, the printer profile selected in step S205 is read out from the storage unit 12 and the calibration method at the time of the profile creation is identified with reference to the identification information described in the printer profile.

However, when the identification information is not described in the printer profile, the calibration method at the time of the profile creation is identified in the following procedures of (1-1) and (1-2).

(1-1) The printer profile selected in step S205 is read out from the storage unit 12 and a combination of predetermined device values (CMYK values) and predetermined device-independent values (L*a*b* values) described in the printer profile is extracted.

(1-2) The calibration method determination criteria corresponding to the calibration methods are sequentially read out from the storage unit 12, and the combination extracted in the above procedure (1-1) and the determination criterion corresponding to each calibration method are collated. Then, the calibration method corresponding to the determination criterion with which the combination extracted in the above procedure (1-1) agrees is identified as the calibration method at the time of the profile creation.

Subsequently, the PC 1 identifies the currently registered calibration method based on the calibration table in the storage unit 12 (step S302). Then, the PC 1 determines whether the calibration methods identified in step S301 and step S302 agree with each other (step S303). Thereafter, the PC 1 returns the process to the flowchart of FIG. 6.

Referring back to FIG. 6, the PC 1 branches the subsequent process according to the determination result of the calibration method determination process in step S206 (step S207). Here, when the determination result is “AGREEMENT” (YES in step S207), the PC 1 displays a determination result notification screen on the display unit 15 and notifies the user that the calibration method at the time of the profile creation agrees with the currently registered calibration method on the same screen (step S216).

FIG. 8 is a schematic diagram illustrating an example of a determination result notification screen U3 displayed in step S216. On the determination result notification screen U3 in FIG. 8, it is notified that the calibration method at the time of the profile creation and the currently registered calibration method agree with each other in a “calibration method determination result” field. A “calibration table optimization” button b2 and a “suitable printer profile selection” button b3 are provided below the “calibration method determination result” field. However, when the determination result is “AGREEMENT” as in the example, these buttons are displayed as grey, and thus are not selected.

Thereafter, the PC 1 receives an instruction of print execution from the user (step S217), and then ends the print setting process. This instruction can be received, for example, when an “OK” button b4 on the determination result notification screen in FIG. 8 is pressed.

Conversely, when the determination result of the calibration method determination process (step S206) is “DISAGREEMENT,” the PC 1 displays a determination result notification screen on the display unit 15 and notifies the user that the calibration method at the time of the profile creation disagrees with the currently registered calibration method on the same screen (step S208).

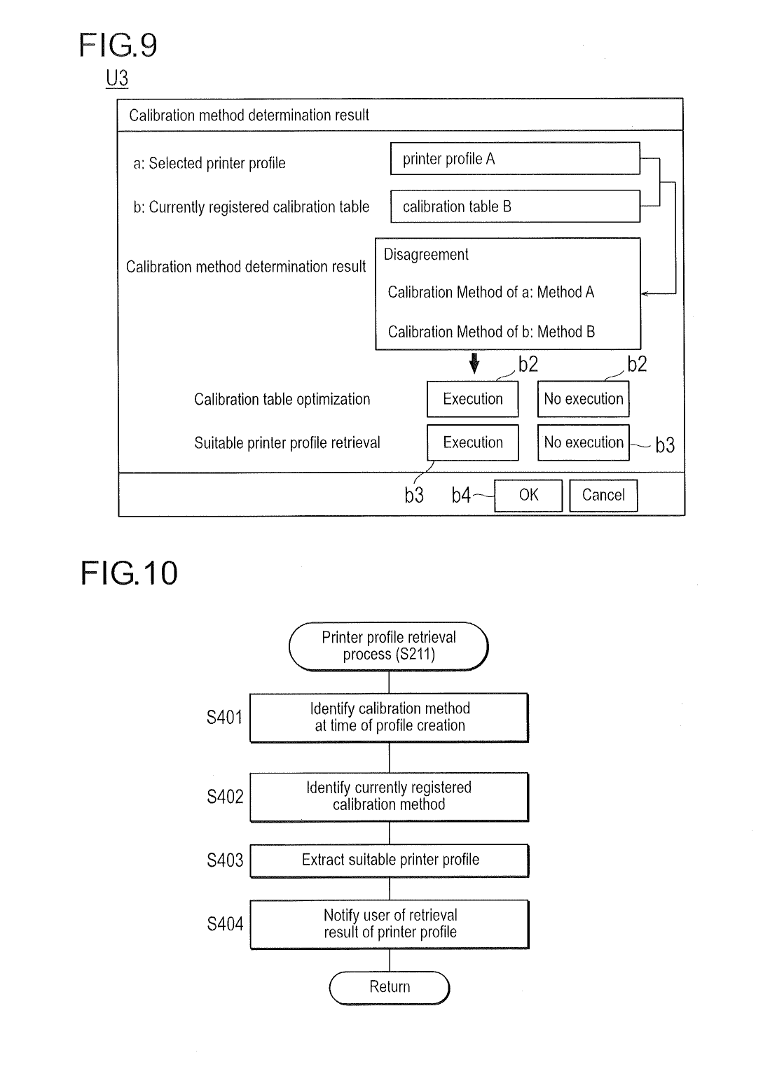

FIG. 9 is a schematic diagram illustrating an example of the determination result notification screen U3 displayed in step S208. On the determination result notification screen U3 in FIG. 9, the user is notified that the calibration method at the time of the profile creation and the currently registered calibration method disagree with each other in the “calibration method determination result” field. As in FIG. 8, a “calibration table optimization” button b2 and a “suitable printer profile retrieval” button b3 are provided below the “calibration method determination result” field. However, when the determination result is “DISAGREEMENT” as in the example, these buttons are displayed so as to be selectable.

Subsequently, the PC 1 determines whether to receive an instruction to retrieve a suitable printer profile or an instruction to optimize the calibration table (step S209 and step S210) and branches the subsequent process according to the determination result. The former instruction is received, for example, when an “execution” button b3 of a “suitable printer profile retrieval” field on the determination result notification screen U3 in FIG. 9 is pressed. The latter instruction is received, for example, when an “execution” button b2 of a “calibration table optimization” field on the determination result notification screen U3 in FIG. 9 is pressed.

Here, when the instruction to retrieve the suitable printer profile is received (YES in step S209), the PC 1 executes a process of retrieving another printer profile to be used instead of the printer profile selected in step S205 (step S211). The process of step S211 is referred to as a “printer profile retrieval process” below.

FIG. 10 is a flowchart illustrating a procedure of printer profile retrieval process. As shown in FIG. 10, the PC 1 first identifies the calibration method at the time of the profile creation corresponding to each of the plurality of printer profiles (excluding the printer profile selected in step S205) in the storage unit 12 (step S401). More specifically, in step S401, each of the plurality of printer profiles is read out from the storage unit 12 and each calibration method at the time of the profile creation is identified with reference the identification information described in it.

However, when the identification information is not described in the printer profile, the calibration method at the time of the profile creation is determined in the following procedures of (2-1), (2-2), and (2-3).

(2-1) The printer profiles are sequentially read out from the storage unit 12 and a combination of predetermined device values (CMYK values) and predetermined device-independent values (L*a*b* values) described in each printer profile is extracted.

(2-2) The calibration method determination criteria respectively corresponding to the calibration methods are sequentially read out from the storage unit 12, and the combination extracted in the above procedure (2-1) and the determination criterion corresponding to each calibration method are collated. Then, the calibration method corresponding to the determination criterion with which the combination extracted in the above procedure (2-1) agrees is identified as the calibration method at the time of the profile creation.

(2-3) The above procedures (2-1) and (2-2) are repeated for the remaining printer profiles in the storage unit 12.

Subsequently, the PC 1 identifies the currently registered calibration method based on the calibration table in the storage unit 12 (step S402). Then, the PC 1 extracts the printer profile which is other than the printer profile selected in step S205 and for which the currently registered calibration method is executed at the time of the creation by comparing the calibration methods identified in step S401 and step S402 (step S403).

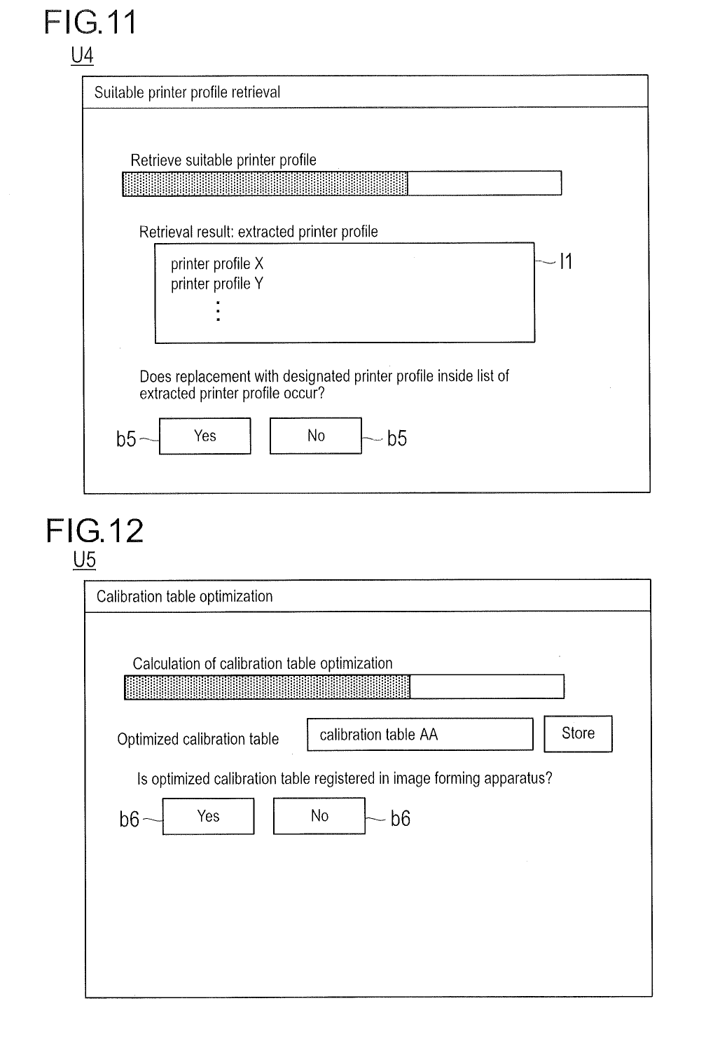

Thereafter, the PC 1 displays a retrieval result display screen on the display unit 15, notifies the user of the retrieval result of the suitable printer profile on the same screen (step S404), and then returns the process to the flowchart of FIG. 6. FIG. 11 is a schematic diagram illustrating an example of a retrieval result display screen U4 displayed in step S404. A retrieval result display screen U4 in FIG. 11 displays the printer profile extracted in the printer profile retrieval process (step S211) inside a list box 11 of the “retrieval result.”

Referring back to FIG. 6, the PC 1 determines whether the suitable printer profile is extracted in the printer profile retrieval process in step S211 (step S212). Then, when the suitable printer profile is extracted (YES in step S212), the PC 1 receives selection of any one printer profile on the retrieval result display screen U4 (step S213). The selection of the printer profile can be received, for example, when any one printer profile in the list box 11 of the retrieval result display screen U4 in FIG. 11 is designated and a “YES” button b5 in the lower portion of the screen is pressed in the designated condition. Thereafter, the PC 1 ends the print setting process.

Conversely, when no suitable printer profile is extracted in the printer profile retrieval process in step S211 (NO in step S212), the PC 1 creates a new calibration table optimized in accordance with the calibration method at the time of the profile creation (step S214). The process of step S214 is referred to as a “calibration table optimization process” below. Also, when the selection of the printer profile is received in step S213, the printer profile selected in step S213 is used in the color conversion process of the controller 2 instead of the printer profile selected in step S205.

When the instruction to optimize the calibration table is received in step S209 and step S210 (NO in step S209 and YES in step S210), the PC 1 creates a new calibration table optimized in accordance with the calibration method at the time of the profile creation (step S214). On the other hand, when neither of the instructions is received (NO in step S209 and NO in step S210), the PC 1 allows the process to proceed to step S217 without executing any process.

FIG. 13 is a flowchart illustrating a procedure of calibration table optimization process. As shown in FIG. 13, the PC 1 first reads out the calibration target table corresponding to the calibration method at the time of the profile creation from the storage unit 12 (step S501). Subsequently, the PC 1 reads out chart color measurement values (see S101 of FIG. 5) at the time of the execution of the currently registered calibration method from the storage unit 12 (step S502). The chart color measurement values are equivalent to the device-independent value (L*a*b* values) corresponding to the device values (CMYK values) before the correction by the currently registered calibration method.

However, when the chart color measurement values at the time of the execution of the currently registered calibration method are not stored in the storage unit 12, the chart color measurement values are calculated in the following procedures of (3-1) and (3-2).

(3-1) The calibration table and the calibration target table corresponding to the currently registered calibration method are read out from the storage unit 12.

(3-2) The device-independent values (L*a*b* values) corresponding to the device values (CMYK values) before the correction by the currently registered calibration method is back-calculated with reference to a correspondence relation between target values (L*a*b* values) corresponding to the device values (CMYK values) after the correction shown in the target table read out in the above procedure (3-1) and output characteristic values (density values, brightness values, etc.) before and after the correction shown in the calibration table read out in the above procedure (3-1).

Subsequently, the PC 1 creates a new calibration table optimized in accordance with the calibration method at the time of the profile creation with reference to the target values (L*a*b* values) shown in the calibration target table read out in step S501 and the chart color measurement values (L*a*b* values) read out in step S502 (step S503). Thereafter, the PC 1 displays the optimization table display screen on the display unit 15 (step S504) and returns the process to the flowchart of FIG. 5. FIG. 12 is a schematic diagram illustrating an example of an optimization table display screen U5 displayed in step S504. Whether the new calibration table is registered in the printer 3 can be selected by pressing any one of registration buttons b6 on the lower side of the screen on the optimization table display screen U5 in FIG. 12.

As in step S503, in the calibration table optimization process of FIG. 13, a new calibration table is directly created with reference to the above target values and color measurement values. In the present embodiment, however, a correction table of the currently registered calibration table may be created with reference to the above target values and color measurement values and a new calibration table may be created based on the correction table and the currently registered calibration table.

Referring back to FIG. 6, when the PC 1 receives an instruction regarding the registration of the new calibration table on the optimization table display screen U5 in FIG. 12 (that is, a “YES” button b6 in FIG. 12 is pressed), the PC 1 registers the new calibration table in the printer 3 (step S215). Conversely, when a “NO” button b6 is pressed on the optimization table display screen U5 in FIG. 12, step S215 is skipped.

Thereafter, the PC 1 receives a print execution instruction (step S217) and terminates the print setting process (END). Also, when the new calibration table is registered in step S215, the newly created calibration table is used for the calibration of the printer 3.

As described above, the print setting apparatus (PC 1) according to the present embodiment can determine whether the calibration method executed at the time of the creation of the color profile for the color conversion agrees with the calibration method currently registered in the image forming apparatus (printer 3), with reference to the color profile for the color conversion and the correction table (calibration table) by the calibration method currently registered in the image forming apparatus (step S206) and notify the user of the determination result (step S208 and step S216). Accordingly, the print setting apparatus according to the present embodiment can effectively prevent color reproduction accuracy of an output image from deteriorating, when the calibration table by the calibration method executed at the time of the creation of the color profile for the color conversion is not registered in the image forming apparatus.

Further, even when the calibration method executed at the time of the creation of the color profile for the color conversion does not agree with the calibration method currently registered in the image forming apparatus (NO in step S207), the print setting apparatus according to the present embodiment can realize color reproduction expected by a user by optimizing the calibration table by the latter calibration method in accordance with the former calibration method (step S214) or by retrieving another color profile suitable for the latter calibration method (step S211).

The present invention is not limited to the above embodiment, but can be modified in various forms within the range of the claims. For example, in the above embodiment, the printer 3 has been adapted as the image forming apparatus that outputs print data. However, the image forming apparatus according to the present invention may be an MFP (Multi-Function Peripheral) that further has a scan function, a copy function, etc. Also, the device-independent values used for the color conversion process of the print data may not be the L*a*b* values, but may be other device-independent values such as XYZ values.

The means and methods of executing the various processes in the print setting apparatus (PC 1) according to the present embodiment may also be realized by one of a dedicated hardware circuit and a program executed on a computer. The program may be provided by a computer-readable recording medium such as a flexible disk or a CD-ROM (Compact Disc Read Only Memory) or may be provided online via a network such as the Internet. In the former case, the program stored in the computer-readable recording medium is generally transmitted to a non-volatile memory such as a ROM or an HDD. Also, the above program may be provided as single application software or may be embedded as one function of the print setting apparatus.

What is claimed is:

1. A print setting apparatus performing print setting of print data to be output by an image forming apparatus capable of executing a plurality of calibration methods, the print setting apparatus comprising:
a selection unit that selects one color profile as a color profile to be used for color conversion of the print data from a plurality of color profiles;
a determination unit that determines whether a first calibration method executed at a time of creation of one color profile selected by said selection unit agrees with a second calibration method currently registered in said image forming apparatus, with reference to the one color profile selected by said selection unit and a calibration table indicating a correspondence relation between output characteristic values of said image forming apparatus before and after correction by said second calibration method; and
a first notification unit that notifies a user of a determination result by said determination unit.

2. The print setting apparatus according to claim 1, wherein said determination unit determines whether said first calibration method agrees with said second calibration method, by identifying said first calibration method based on identification information described in advance in the one color profile selected by said selection unit and identifying said second calibration method based on the calibration table.

3. The print setting apparatus according to claim 1, wherein said determination unit determines whether said first calibration method agrees with said second calibration method, by identifying said first calibration method based on a correspondence relation between a device value and a device-independent value shown in the one color profile selected by said selection unit and identifying said second calibration method based on the calibration table.

4. The print setting apparatus according to claim 3, wherein said determination unit identifies said first calibration method by collating the correspondence relation between the device value and the device-independent value shown in the one color profile selected by said selection unit and a correspondence relation, which is stored in advance in the print setting apparatus, between a device value and a device-independent value after the correction by said second calibration method.

5. The print setting apparatus according to claim 1, further comprising
a retrieval unit that retrieves, among the plurality of color profiles, a color profile which is other color profile different from the one color profile selected by said selection unit and for which said first calibration method is executed at the time of creation of the other color profile, when it is determined that said first calibration method does not agree with said second calibration method, and
a second notification unit that notifies the user of a retrieval result of said other color profile by said retrieval unit.

6. The print setting apparatus according to claim 5, wherein said retrieval unit retrieves said other color profile by identifying a calibration method executed at a time of creation of each of the plurality of color profiles based on identification information described in advance in each of the plurality of color profiles.

7. The print setting apparatus according to claim 5, wherein said retrieval unit retrieves said other color profile by identifying a calibration method executed at a time of creation of each of the plurality of color profiles based on a correspondence relation between a device value and a device-independent value shown in each of the plurality of color profiles.

8. The print setting apparatus according to claim 7, wherein said retrieval unit identifies the calibration method executed at the time of the creation of each of the plurality of color profiles by collating the correspondence relation between the device value and the device-independent value shown in each of the plurality of color profiles and a correspondence relation, which is stored in advance in the print setting apparatus, between a device value and a device-independent value after the correction by each of the plurality of calibration methods.

9. The print setting apparatus according to claim 1, further comprising an optimization unit that optimizes the calibration table in accordance with said first calibration method, when it is determined that said first calibration method does not agree with said second calibration method.

10. The print setting apparatus according to claim 9, wherein said optimization unit creates a new calibration table to be used instead of the calibration table with reference to a color measurement value of the device-independent value corresponding to the device value before the correction by said second calibration method and a target value of the device-independent value stored in advance in the print setting apparatus and corresponding to the device value after the correction by said first calibration method.

11. The print setting apparatus according to claim 10, wherein said color measurement value is calculated based on the target value of the device-independent value stored in advance in the print setting apparatus and corresponding to the device value after the correction by said second calibration method, and the correspondence relation between the output characteristic values of said image forming apparatus shown in the calibration table.

12. The print setting apparatus according to claim 3, wherein the device-independent value is an L*a*b* value.

13. A non-transitory computer readable recording medium stored with a control program of a print setting apparatus performing print setting of print data to be output by an image forming apparatus capable of executing a plurality of calibration methods, the control program causing said print setting apparatus to execute the procedures for:
(A) selecting one color profile as a color profile to be used for color conversion of the print data from a plurality of color profiles;
(B) determining whether a first calibration method executed at a time of creation of the one color profile selected in said procedure (A) agrees with a second calibration method currently registered in said image forming apparatus, with reference to the one color profile selected in said procedure (A) and a calibration table indicating a correspondence relation between output characteristic values of said image forming apparatus before and after correction by said second calibration method; and
(C) notifying a user of a determination result in said procedure (B).

14. The non-transitory computer readable recording medium according to claim 13, wherein in said procedure (B), it is determined whether said first calibration method agrees with said second calibration method, by identifying said first calibration method based on identification information described in advance in the one color profile selected in said procedure (A) and identifying said second calibration method based on the calibration table.

15. The non-transitory computer readable recording medium according to claim 13, wherein in said procedure (B), it is determined whether said first calibration method agrees with said second calibration method by identifying said first calibration method based on a correspondence relation between a device value shown in the one color profile selected in said procedure (A) and a device-independent value and identifying said second calibration method based on the calibration table.

16. The non-transitory computer readable recording medium according to claim 15, wherein in said procedure (B), said first calibration method is identified by collating the correspondence relation between the device value shown in the one color profile selected in said procedure (A) and the device-independent value and a correspondence relation, which is stored in advance in said print setting apparatus, between a device value and a device-independent value after the correction by said second calibration method.

17. The non-transitory computer readable recording medium according to claim 13, wherein the control program causes said print setting apparatus to further execute the procedures of
(D) retrieving, among the plurality of color profile, a color profile which is other color profile different from the one color profile selected in said procedure (A) and for which said first calibration method is executed at the time of creation of the other color profile, when it is determined that said first calibration method does not agree with said second calibration method in said procedure (B), and
(E) notifying the user of a retrieval result of said other color profile by said procedure (D).

18. The non-transitory computer readable recording medium according to claim 17, wherein in said procedure (D), said other color profile is retrieved by identifying a calibration method executed at a time of creation of each of the plurality of color profiles based on identification information described in advance in each of the plurality of color profiles.

19. The non-transitory computer readable recording medium according to claim 17, wherein in said procedure (D), said other color profile is retrieved by identifying a calibration method executed at a time of creation of each of the plurality of color profiles based on a correspondence relation between a device value and a device-independent value shown in each of the plurality of color profiles.

20. The non-transitory computer readable recording medium according to claim 19, wherein in said procedure (D), the calibration method executed at the time of the creation of each of the plurality of color profiles is identified by collating the correspondence relation between the device value and the device-independent value shown in each of the plurality of color profiles and a correspondence relation, which is stored in advance in said print setting apparatus, between a device value and a device-independent value after the correction by each of the plurality of calibration methods.

21. The non-transitory computer readable recording medium according to claim 13, wherein the control program causes said print setting apparatus to further execute the procedure (F) of optimizing the calibration table in accordance with said first calibration method, when it is determined that said first calibration method does not agree with said second calibration method in said procedure (B).

22. The non-transitory computer readable recording medium according to claim 21, wherein in said procedure (F), a new calibration table to be used instead of the calibration table is created with reference to a color measurement value of the device-independent value corresponding to the device value before the correction by said second calibration method and a target value of the device-independent value stored in advance in said print setting apparatus and corresponding to the device value after the correction by said first calibration method.

23. The non-transitory computer readable recording medium according to claim 22, wherein the color measurement value is calculated based on the target value of the device-independent value stored in advance in said print setting apparatus and corresponding to the device value after the correction by said second calibration method and the correspondence relation between the output characteristic values of said image forming apparatus shown in the calibration table.

24. The non-transitory computer readable recording medium according to claim 15, wherein the device-independent value is an L*a*b* value.
